(19) United States
(12) Patent Application Publication
(10) Pub. No.: US 2003/0017292 A1
(43) Pub. Date: Jan. 23, 2003

(54) Assembly adhesive tape for the improved sealing of joints and assembly adhesive tape dispenser

(76) Inventors: Reto Sieber, Sigigen (CH); Marco Sieber, Horw (CH)

Correspondence Address: JORDAN AND HAMBURG LLP, 122 East 42nd Street, New York, NY, 10168, US

(21) Appl. No.: 09/911,142

(22) Filed: Jul. 23, 2001

(51) Int. Cl. B32B 3/10; B32B 3/04

(52) U.S. Cl. 428/40.1; 428/906; 428/137; 428/124

(57) ABSTRACT

A pressure-sensitive tape for closing, sealing and gluing in house construction, with a backing layer (1) on the upper side of the tape and with an adhesive layer (2), which is on the underside of the tape and provided with a protective film (3), which can be pulled off, the protective film having at least one slit (6) in the longitudinal direction and the tape being folded upon itself along the slit (6) in such a manner, that at least a portion of the protective film (3) is disposed on the outside, and at least one lateral longitudinal section being provided, which is perforated.

The present invention relates to a pressure-sensitive tape for closing, sealing and gluing joints in house construction, a so-called assembly adhesive tape, which is suitable particularly for joints in corners and edges, as well as to a dispenser for such a tape. Such adhesive tapes are used, for example, in house construction, when different structural elements, such as doors or windows, are to be inserted in an external wall of a house and the joint, which arises between the element and the external wall of the house, must be closed off. Such pressure-sensitive tapes have a backing layer and, connected therewith, an adhesive layer, the latter usually being provided with a protective layer, which can be pulled off.

A problem of such pressure-sensitive tapes is the difficulty in applying the tape in areas, to which access is difficult, so that it nevertheless seals the joint well, which is to be closed off, and, at the same time, in gluing the backing smoothly to the edge section of a joint, in order to close off the joint as air-tight and moisture-tight as possible.

A further problem consists therein that, when the tape is processed, the protective film frequently can be removed from the adhesive layer only with difficulty, since no means are provided at the smooth cut edges of the adhesive tape for lifting and pulling off the protective film from the section of the tape, which is to be glued.

It is therefore an object of the invention to provide a pressure-sensitive tape for closing off, sealing and gluing joints, which can be glued easily and effectively even in areas, to which access is difficult, such as corners and edges, which adheres securely and for a long time to any background and which furthermore makes the gluing process and the use of the tape in these areas easier. A further object of the invention is to improve the storage, transport and processing of the pressure-sensitive tape.

This objective is accomplished with a pressure-sensitive tape having the distinguishing features named in claim 1 and with a dispenser for an adhesive tape of claim 17. Advantageous embodiments and further developments are the object of the dependent claims.

The protective film of the inventive, pressure-sensitive tape has at least one slit in the longitudinal direction and the tape is folded upon itself in the transverse direction along this slit, so that at least a portion of the protective film is disposed on the outside. In this manner, the protective film can easily be raised from the adhesive film to its two sides at the fold of the tape and pulled off, since the protective film is slit at the fold and, as a result, the edges of the protective film are in each case detached somewhat from the adhesive layer. It is easy to take hold of the edges of the protective film, which has previously already become somewhat detached, and to do so even under difficult conditions, so that the problem of a protective film, which cannot be detached or is difficult to pull off, does not exist. Moreover, because of the folding and the slit protective film, the tape can also be processed more easily. To begin with, the tape can be glued on parallel to the joint and corner in the corner joints, which are to be glued, with only a portion of the protective film pulled off, and afterwards, when the adhesive tape is already glued to one side of the joint section, the protective film on the opposite side can easily be pulled off and the adhesive tape can be glued completely over the joint. By pre-folding the adhesive tape, it is avoided that the glued tape is folded or shifted unintentionally, which could lead to undesirable leaks and problems with the further processing of the glued region of the joint.

When the pressure-sensitive tape is glued over joints, which are in 90° corners (such as joints between window frames and external walls of a house) the pre-folded tape ensures very precise gluing in the respective corner.

The tape can be glued separately and consecutively with the folded longitudinal sections. As a result, it is prevented that the strongly adhering tape is glued in an untidy manner and visible residues of adhesive or adhesive tape remain behind when the tape is pulled off and glued once more. In addition, there are no indications of glue lines since, because it is pre-folded, the tape can be glued very accurately and straight in the corners, so that the processing is simplified significantly.

A further advantage of the pre-folding lies in the time saved during the processing of the pressure-sensitive tape. The previously required manual pre-folding of the tape, piece by piece, is omitted completely, so that, when the inventive tape is processed, the gluing time can be shortened by up to a half.

The tape has at least one lateral longitudinal section, that is, a region at a longitudinal side of the adhesive tape, in which the backing and the adhesive layer are perforated. In this connection, perforation means that at least one row of continuous openings is provided in the backing and the adhesive layer. Due to the perforation, the adhesion of the tape is improved when it is subsequently plastered over with plaster or gypsum or the like, because the plaster adheres in the openings of the perforation directly to the background and intensifies the adhesion of the tape even on a porous background. By these means, it is avoided that the moisture and weight of a layer of plaster, which has been applied, can detach the tape from the background and thus lead to leaks or cause the layer of plaster to break up. Even when wallpaper or decorative panels are subsequently glued over the tape, the adhesive bond between the adhesive layer and the background is improved. The perforation is provided only at one lateral longitudinal section of the adhesive tape, so that the central region of adhesive can ensure the sealing function of the adhesive tape reliably. The perforation of the lateral, longitudinal section of the adhesive tape can be formed by essentially circular, polygonal or oval openings, which preferably are distributed uniformly. By these means, it is achieved that the adhesive function of the adhesive layer is affected as little as possible and, nevertheless, a layer of material, which is to be applied on the adhesive tape, can penetrate through the openings to the background, to which the adhesive tape is glued. A secure hold is assured with the inventive adhesive tape owing to the fact that the perforation openings permit partial penetration of the tape by a layer, such as plaster, which is to be applied subsequently on at least a partial region of the tape.

According to an advantageous embodiment of the invention, the tape is slit twice and folded along one of the slit in the transverse direction. This has the advantage that the protective film can be pulled off successively from the adhesive layer in small longitudinal sections, so that the adhesive tape can be put in place even more easily and glued more accurately. To begin with, the tape can be glued in a very small edge section and, subsequently, the next section of protective film can be pulled off in order to glue the tape further. Only at the very end is it necessary to pull off the last protective film section, for example, the section on the bent-over side of the tape, which until then has offered protection against contamination or to gluing in an unintended manner.

According to a further advantageous development of the invention, the backing is paper and/or a plastic film and the adhesive layer is a pressure-sensitive acrylate glue. As a result, the pressure-sensitive tape, even in the folded state, is only insignificantly thicker than conventional assembly adhesive tapes, and it applies only very little in the glued state in comparison to the background of the adhesive, so that the adhesive tape can also be glued in regions, in which, for example, floor coverings, wallpaper or plaster is subsequently to be applied. The acrylate adhesive is suitable, on the one hand, because of its good pressure-sensitive adhesive properties, especially for gluing corner joints and, on the other, because it ensures a long-lasting adhesive effect even under extreme weather and weathering conditions, such as those encountered outside.

According to a further advantageous development of the invention, the backing is such that it can be torn by hand transversely to the longitudinal direction of the tape. By these means, the tape can be divided easily into longitudinal sections corresponding to the length of the joints. The tape therefore can be processed more easily.

According to a further advantageous development of the invention, the adhesive layer has a non-adhering central strip and the protective film is slit and folded along a line between the non-adhering central strip and an adjoining adhesive layer. This is particularly advantageous for gluing joints between two structural elements, which adjoin one another at right angles, since skewed or shifted gluing especially in the contact area of structural elements is prevented by these means in a simple manner. Nevertheless, the adhesive tape ensures that the joint is sealed and closed off reliably even over edges and corners, since the two outer edge, adhesive regions of the tape are sufficiently wide and therefore glued only on flat surfaces.

According to a further advantageous development of the invention, the tape, in the folded state, is rolled up into an adhesive tape roll. The adhesive layer, open at the fold, cannot adhere to other adhesive tape regions in this manner and a swift and simple processing of the adhesive tape without prior preparation for the adhesive process is possible. Appropriate pieces of tape, cut to length, can easily be taken from the roll and glued immediately on one side after the protective film is pulled off. The step of pre-folding before the tape is applied on the joint, which is to be closed off, is omitted; gluing a joint can therefore be carried out more rapidly and less expensively than before.

According to a further advantageous development of the invention, an intermediate layer is provided at least at the folded side of the roll. The intermediate layer ensures that the rolled-up and folded tape cannot adhere to the open, adhesive side of the fold during transport or storage. In addition, it is prevented by these means that contamination and the like can collect at this side and have a disadvantageous effect on the gluing action of the tape.

According to a further advantageous development of the invention, the tape is rolled up on a matching unrolling device, from which it can be rolled off once again. As a result, the cumbersome unpacking and storage of the pressure-sensitive tape can be omitted, since the latter can simply be unrolled once again from the unrolling device and cut off in the required length from the roll. However, the unrolling device not only simplifies the removal of the tape, but also serves as a protective and transporting packaging material. Moreover, the unrolling device can be used as a processing means in that, for example, the pressure-sensitive tape is unrolled a piece from the device, the pressure-sensitive film is pulled off piecewise on one of the folded sides and, subsequently, the tape is unrolled and glued on one of the joint sides continuously and directly from the roll over a longer distance.

In a further development of the invention, which is advantageous in this respect, means, which prevent adhesion in and with the unrolling device, are provided at the folded side. For this purpose, for example, a siliconized paper, the diameter of which corresponds to that of the roll, can be placed on the rolled-up tape, from which it can be removed once again easily in spite of slight adhesion to the tape at the fold. The siliconized paper prevents lateral adhesion in the interior of the unrolling device, because it adheres slightly to the side of the tape roll and rotates on the device along with the roll during the unrolling or pulling out.

In accordance with an advantageous embodiment of the invention, the openings of the perforated longitudinal section have an average diameter of at least 3 millimeters.

According to an advantageous development of the invention, two lateral longitudinal sections are provided, which are perforated. With such an adhesive tape, joints between components in interior work can be sealed, for which the adhesive tape is subsequently worked over with a material on either side of the joint. Nevertheless, irrespective of the thickness of the plaster layer, which is to be applied on the adhesive tape, sealing of the joint region is ensured owing to the fact that the adhesive tape is not perforated in the center. The unperforated section is wider here than the maximum width of the joint, which is to be sealed.

According to a further advantageous development of the invention, the perforated, longitudinal section is at a distance from the non-adhering central strip. This has the advantage that the tape can be glued smoothly at corners or edges without creasing, since the central strip, which does not adhere, enables the tape to be pressed into corners without adhering immediately and forming folds during the gluing. Owing to the fact that the perforated longitudinal section is at a distance from the central strip, the perforation openings are prevented from leading to leaks when the joint, which is to be sealed, is covered with the non-adhering central strip.

According to a further advantageous development of the invention, the backing, the adhesive layer and the protective film, which can be pulled off, are perforated. From a manufacturing point of view, this has the advantage that the tape can be produced in a simple manner. The protective film prevents a perforation tool, such as a stamping device, coming into contact with the adhesive layer of the pressure-sensitive tape.

According to a further advantageous development of the invention, the backing consists of a material, which has good adhesion properties for plaster. Such good adhesion properties are ensured, for example, by a material with open pores. The bond between the plaster and the backing and, accordingly, also the adhesion of the tape to the background are improved by these means. A detachment or breaking off of parts of the plaster is prevented reliably.

According to a further advantageous aspect of the invention, a dispenser is provided for the pressure-sensitive tape, which is rolled up into a roll. This dispenser essentially encloses the roll and has at least one outlet slot for the adhesive tape. The dispenser has the advantage of being a protective cover during transport and, at the same time, of simplifying the handling and continuous processing of the pressure-sensitive tape. Even in a very dusty environment, dirt is prevented from reaching the exposed adhesion sites and reducing the adhesive force. The adhesive tape, surrounded by the dispenser, can simply be unwound out of the outlet slot and removed continuously (in the case of long adhesive sites) or piece by piece (in the case of short adhesive sites) from the dispenser and glued or cut and glued.

An example of the inventive assembly adhesive tape, as well of the assembly tape dispenser is shown in the drawing, which is described in detail in the following with reference to the Figures and in which

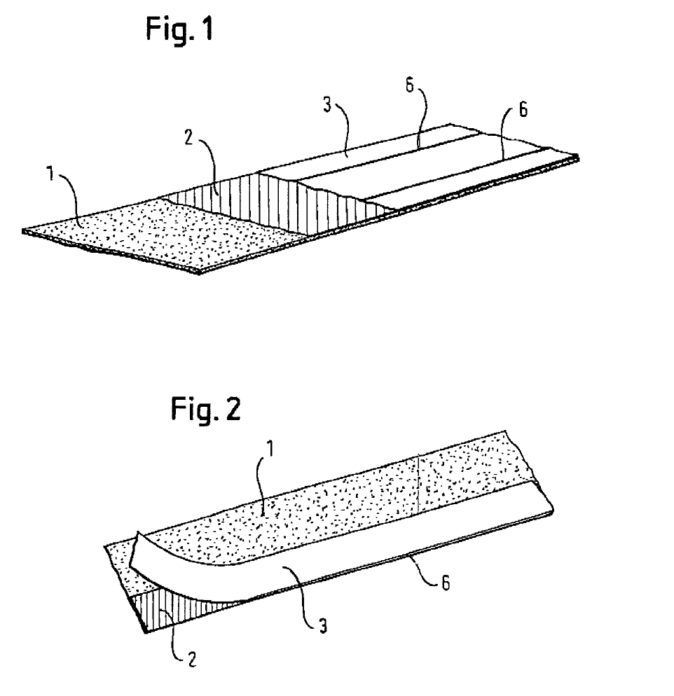

FIG. 1 shows a first embodiment of an assembly adhesive tape, which has not yet been folded upon itself,

FIG. 2 shows the assembly adhesive tape of FIG. 1, a portion of which has been folded upon itself,

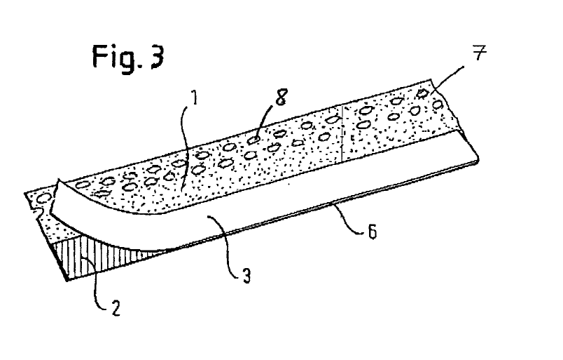

FIG. 3 shows a second embodiment of an inventive, pressure-sensitive tape with a perforated longitudinal section and

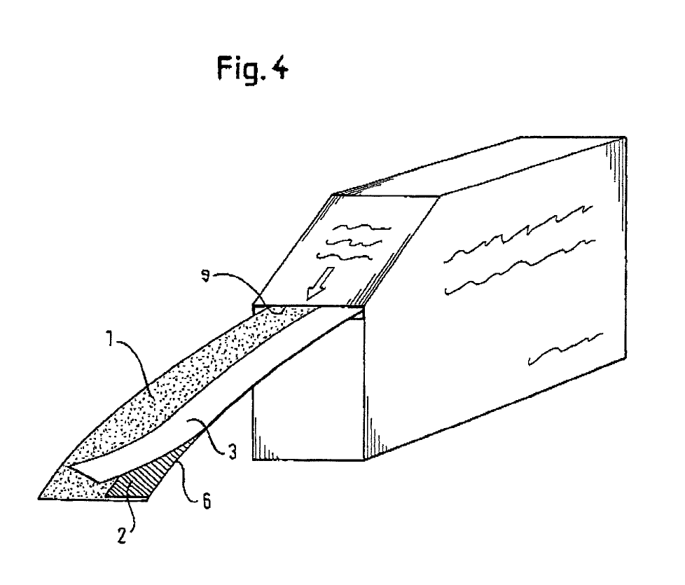

FIG. 4 shows a diagrammatic representation of an inventive assembly adhesive tape, which has been folded upon itself.

In FIG. 1, an assembly adhesive tape is shown, which has a backing layer 1, an adhesive layer 2 and a protective film 3. The protective film 3 has two slits 6 in the longitudinal direction of the tape. By providing two longitudinally disposed slits 6, it is accordingly possible to fold the regions of the assembly tape, which lie on the outside, on themselves, the slits 6 being disposed in such a manner, so that either the folded-over regions of tape lie on top of one another or the regions of the tape are folded onto the tape in such a manner, that the folded regions are not disposed over one another.

In FIG. 2, the inventive assembly adhesive tape is shown, which basically has the structure of the tape of FIG. 1; the assembly adhesive tape has the backing 1, the adhesive layer 2, which preferably consists of acrylate adhesive, and the protective film 3. The assembly adhesive tape is folded on itself along an essentially continuous slit 6. The tape has a width of 3 to 4 cm. It is also possible to dispose the slit 6 of the protective film essentially in the center of the tape, so that the tape is folded in half onto itself. According to FIG. 2, only a portion of the whole width of the tape is folded upon itself along the slit 6. The adhesive 2 consists of more than 100 g/m² of acrylate adhesive and preferably of 200 g/m². The tape is folded along the slit 6 in the protective film 3 in such a manner, that the protective film, which consists, for example, of a siliconized paper, can easily be detached from the adhesive layer 2 in the fold and therefore taken hold of, without any problems, by hand and pulled off. In the folded state, the whole tape is rolled up into a roll and provided laterally with intermediate layers for transport and packaging. The intermediate layers are, for example, circular siliconized paper sheets, the diameter of which corresponds to the diameter of the rolled-up tape. The circular paper sheets are siliconized, so that the tape can easily be detached from them even when the exposed fold adheres slightly. However, other means, known to those skilled in the art, can also be provided as abhesive means.

At least on the side averted from the adhesive layer 2, the backing 1 is constructed in a light color, such as white or the like. As a result, a joint, sealed with the adhesive tape, can also be provided with a thin layer of plaster, a thin bright layer of paint and the like, without the color of the tape subsequently interfering by showing through or emerging. In this example, the tape is constructed in a width of 3 to 4 cm. However, it is self evident that, depending on the requirements and the width of the joint, which is to be sealed, inventive pressure-sensitive tapes, which are wider, up to a maximum of 50 cm, can also be provided.

In FIG. 3, an assembly adhesive tape is shown, which has a backing 1, an adhesive layer 2 and a protective film 3, which is provided at the adhesive layer 2. In FIG. 3, a portion of the adhesive tape is folded upon itself. Accordingly, a pre-folded assembly adhesive tape is formed, which is pre-folded at the slit 6 of the protective film 3 in such a manner that, initially, a portion of the protective film 3 can be pulled off and, for example, easily be glued in an edge region or a corner region, before the other part of the protective film 3 (in FIG. 3, on the reverse side of the adhesive tape, which is not shown) can be pulled off and glued. The backing 1 and the adhesive layer 2 are perforated, that is, provided with several openings passing through, in a longitudinal section 7 of the assembly adhesive tape. The perforation of the longitudinal section 7, as in the example shown, may consist of round openings 8 or have openings in a polygonal, oval or undefined form. The openings of the perforation of the longitudinal section 7 may be distributed uniformly or become smaller or reduced in number in the direction of the lateral edge of the assembly adhesive tape. Preferably, the perforation openings in the longitudinal section 7 are provided with an average diameter of at least 3 mm, so that sufficient penetration of plaster, which is applied on the backing after the assembly adhesive tape is processed, is ensured and the plaster achieves an additional holding effect by bonding with the background. Because of the openings of the perforation, the adhesive effect admittedly is reduced in the longitudinal section 7 of the perforation when the assembly adhesive tape is glued on. However, this is subsequently more than compensated for by the plaster that is to be applied. Advantageously, it is avoided that the layer of plaster or the like exerts such a strain on the backing of the adhesive tape, that the latter runs the danger of detaching from the background and no longer being tight.

In FIG. 4, a diagrammatic representation of an assembly tape dispenser is shown, in which an assembly tape of FIG. 2, which is folded upon itself, is accommodated. For use, the assembly adhesive tape is passed out of the dispenser to an outlet slot 9, which is disposed at the front of the dispenser. The dispenser preferably is produced from cardboard and the assembly adhesive tape advisably is offered and can be used in the unit with the assembly adhesive tape. This has the advantage that the assembly adhesive tape is protected against contamination, particularly at the direct fold lines, since parts of the adhesive layer are exposed along these fold lines. Accordingly, not only can an assembly adhesive tape be transported reliably with the dispenser, but also be used safely and protected against contamination at a building site. The dispenser may be constructed as a disposable article, that is, discarded when the assembly adhesive tape is used up, or constructed as a refillable box.

1. A pressure-sensitive tape for closing, sealing and gluing joints in house construction, particularly joints in corners and edges, with a backing layer on the upper side of the tape and an adhesive layer, which is on the underside of the tape and provided with a protective film, wherein the protective film has at least one slit in the longitudinal direction and the tape is folded upon itself in the transverse direction along the slit in such a manner, that at least a portion of the protective film is disposed on the outside and that at least a lateral longitudinal section is provided, which is perforated.

2. The tape of claim 1, wherein the tape is slit twice and folded along one of the slits in the transverse direction.

3. The tape of claims 1 or 2, wherein the backing consists of paper and/or a plastic film and the adhesive layer is a pressure-sensitive acrylate adhesive.

4. The tape of one of the preceding claims, wherein the backing is such, that it can be tom by hand transversely to the longitudinal direction of the tape.

5. The tape of one of the preceding claims, wherein the adhesive layer has a non-adhering central strip and the protective film is slit along a line between the non-adhering central strip and the adjoining adhesive layer and is folded along the line.

6. The tape of one of the preceding claims, wherein the tape, in a folded state, is rolled up into a roll of adhesive tape.

7. The tape of claim 6, wherein an intermediate layer is provided at least at the folded side of the roll.

8. The tape of one of the preceding claims, wherein the tape is rolled up on a matching unrolling device, from which it can be unrolled once again.

9. The tape of claim 8, wherein means are provided at least at the folded side for preventing adhesion to the unrolling device.

10. The tape of one of the preceding claims, wherein the tape is at least 3 to 4 cm wide in the not folded state.

11. The tape of one of the preceding claims, wherein two lateral longitudinal sections, which are perforated, are provided in each case at side regions.

12. The tape of one of the preceding claims, wherein a non-adhering central strip is provided and the perforated longitudinal section is at a distance from the central strip.

13. The tape of one of the preceding claims, wherein the backing, the adhesive layer and the protective film, which can be pulled off, are perforated.

14. The tape of one of the preceding claims, wherein the backing consists of a material, particularly of an open-pored material, which exhibits good adhesion properties for plaster.

15. The tape of one of the preceding claims, wherein the perforated section has openings with an average diameter of at least 3 millimeters.

16. The tape of claim 15, wherein the openings are essentially circular, polygonal or oval.

17. A dispenser for a rolled-up pressure-sensitive tape of one of the claims 1 to 16, which essentially surrounds the roll of adhesive tape and has at least one outlet slot for the tape.

18. The dispenser of claim 17, wherein cardboard is used as material.
